(19) United States
(12) Patent Application Publication
(10) Pub. No.: US 2023/0067332 A1
(43) Pub. Date: Mar. 2, 2023

(54) IMAGE CAPTURING APPARATUS, CONTROL METHOD OF IMAGE CAPTURING APPARATUS, AND STORAGE MEDIUM

(71) Applicant: CANON KABUSHIKI KAISHA, Tokyo (JP)

(72) Inventor: Shingo Hirayama, Kanagawa (JP)

(21) Appl. No.: 17/821,574

(22) Filed: Aug. 23, 2022

(30) Foreign Application Priority Data
Aug. 30, 2021 (JP) 2021-139715

(51) Int. Cl. H04N 5/235

(52) U.S. Cl. CPC H04N 5/2351; H04N 5/2354

(57) ABSTRACT

An image capturing apparatus that shifts an image capturing mode between a first mode in which a filter for attenuating infrared light is inserted to an optical path of an imaging optical system and a second mode in which the filter is removed from the optical path of the imaging optical system and captures an image by the imaging optical system, the image capturing apparatus includes a control unit configured to determine whether a first visible light level detected by the visible light sensor is normal, based on a difference value between the first visible light level and a second visible light level, in which the second visible light level is acquired by estimating based on a parameter regarding exposure, and wherein the control unit changes a predetermined threshold value used to shift the image capturing mode, based on a result of the determination.

### BACKGROUND OF THE DISCLOSURE

### Field of the Disclosure

The present disclosure relates to an image capturing apparatus, a control method of the image capturing apparatus, and a storage medium.

### Description of the Related Art

Cameras connected to a network (hereinafter, called network cameras) have been utilized. Among the network cameras is a network security camera capable of operating in a day mode and a night mode. In the day mode, image capturing is performed using an infrared ray (IR) cut filter set in front of an image sensor, to allow only visible light to pass in. In the night mode, visibility in a low-illuminance environment is improved by removing the IR cut filter from the front of the image sensor and allowing infrared light to pass in. It is often the case that a network camera capable of operating in the day mode and the night mode has a mode shifting function called an auto-day-night (ADN) function which enables the network camera to automatically shift a mode between the day mode and the night mode based on a luminance value acquired from a captured image. Further, some of the network security cameras have an infrared illumination function, and thus a bright image can be captured even in a dark image capturing environment, by an infrared illumination turned on in image capturing in the night mode. However, in a case where mode shifting is performed based on only a luminance value of the captured image, the network camera cannot distinguish between an image capturing environment which brightens and an image capturing environment which is still dark but is brightened by the infrared illumination. Thus, in most cases, the network camera having the infrared illumination function also includes a visible light sensor. When a detection value acquired by the visible light sensor is a threshold value or more, the network camera determines that the image capturing environment has brightened and shifts the mode to the day mode.

Japanese Patent Application Laid-Open No. 2014-11635 discusses a technique which enables an image capturing apparatus to appropriately perform ADN control based on a result of comparison between a last shifting evaluation value (learned value), used when a day mode is changed to a night mode, and a latest shifting evaluation value. According to the technique discussed in Japanese Patent Application Laid-Open No. 2014-11635, in a case where a result of comparison between the last shifting evaluation value and the latest shifting evaluation value falls within a predetermined range, it is determined that the mode is shifted at an intended level of brightness of an environment. On the other hand, in a case where a result of the comparison falls outside of the predetermined range, it is determined that the mode is shifted at an unintended level of brightness of the environment.

### SUMMARY OF THE DISCLOSURE

According to an aspect of the present disclosure, an image capturing apparatus that shifts an image capturing mode between a first mode in which a filter for attenuating infrared light is inserted to an optical path of an imaging optical system and a second mode in which the filter is removed from the optical path of the imaging optical system and captures an image by the imaging optical system, the image capturing apparatus includes a control unit configured to shift the second mode to the first mode, based on a predetermined threshold value, an acquisition unit configured to acquire, in a case where the second mode is shifted to the first mode, a parameter regarding exposure of the image capturing apparatus and a first visible light level indicating brightness of visible light detected by a visible light sensor, and an estimation unit configured to estimate a second visible light level indicating brightness of visible light entering an image sensor of the image capturing apparatus, based on the parameter regarding exposure, wherein the control unit determines whether the first visible light level detected by the visible light sensor is normal, based on a difference value between the first visible light level and the second visible light level, and wherein the control unit changes the predetermined threshold value, based on a result of the determination.

Further features of the present disclosure will become apparent from the following description of exemplary embodiments with reference to the attached drawings.

### BRIEF DESCRIPTION OF THE DRAWINGS

FIG. 1 is a block diagram illustrating an example of a schematic configuration of an image capturing apparatus according to a first exemplary embodiment.

FIG. 2 is a flowchart illustrating control processing according to the first exemplary embodiment.

FIG. 3 is a flowchart illustrating control processing according to a second exemplary embodiment.

FIG. 4 is a flowchart illustrating control processing according to a third exemplary embodiment.

FIGS. 5A and 5B are diagrams illustrating examples of a notification according to the third exemplary embodiment.

FIG. 6 is a block diagram illustrating a hardware configuration of the image capturing apparatus according to any one of the first to the third exemplary embodiments.

### DESCRIPTION OF THE EMBODIMENTS

Hereinafter, exemplary embodiments according to the present disclosure will be described with reference to the appended drawings. The exemplary embodiments described hereinafter are not intended to limit the contents of the present disclosure, and not all of the combinations of features described in the exemplary embodiments are required as the solutions of the present disclosure. Configurations described in the exemplary embodiments can be modified or changed as appropriate depending on specifications of an apparatus, to which the present disclosure is applied, and various conditions, such as a use condition and a use environment. Further, a part of the below-described exemplary embodiments may be combined as appropriate. In the below-described exemplary embodiments, the same reference numerals are applied to the constituent elements similar to each other.

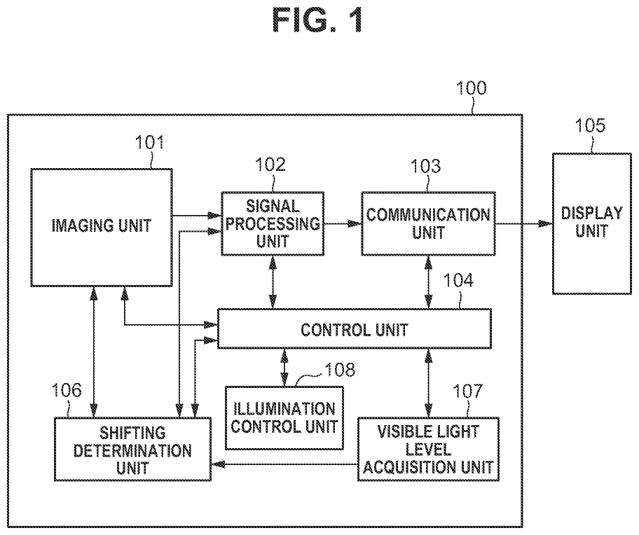

FIG. 1 is a block diagram illustrating a configuration example of an image capturing apparatus 100 according to a first exemplary embodiment. In the present exemplary embodiment, a network camera is described as an example of the image capturing apparatus 100. Descriptions of the network to which the network camera is connected and descriptions of a configuration of an apparatus connected to the network camera according to the present exemplary embodiment via the network are omitted.

The image capturing apparatus 100 illustrated in FIG. 1 is connected to a display unit 105 to communicate with each other. In the present exemplary embodiment, the image capturing apparatus 100 and the display unit 105 are described as separate entities. However, the image capturing apparatus 100 and the display unit 105 can be configured integrally. The image capturing apparatus 100 can transmit a captured image signal to the display unit 105 or an external apparatus, such as a server (not illustrated), via a communication unit 103.

An imaging unit 101 performs image capturing by taking light in from the outside to generate an image signal of an object. The imaging unit 101 includes a lens group, an infrared ray (IR) cut filter, an image sensor, a correlated double sampling (CDS) circuit, an automatic gain control (AGC) amplifier, and an analog-to-digital (A/D) conversion unit, which are not illustrated. The lens group includes an aperture mechanism.

The IR cut filter is disposed in front of the image sensor in an insertable/removable state, and the control unit 104, below-described, controls an infrared ray cut filter (IRCF) insertion/removal mechanism (not illustrated) to insert or remove the IR cut filter. The image capturing apparatus 100 has a function of performing image capturing in a first mode and a second mode. In the first mode, image capturing is performed using the IR cut filter set in the front of the image sensor to allow only visible light to pass in. In the second mode, visibility in a low-illuminance environment is improved by removing the IR cut filter and allowing infrared light to pass in. In the below-described present exemplary embodiment, the first mode in which image capturing is performed in a state where the IR cut filter is inserted in front of the image sensor is called a day mode, and the second mode in which the image capturing is performed in a state where the IR cut filter is removed from the front of the image sensor is called a night mode.

In the day mode, light passing through the lens group and the IR cut filter forms an optical image of an object on the image sensor configured of a charge coupled device (CCD) sensor or a complementary metal-oxide semiconductor (CMOS) sensor. On the other hand, in the night mode, the IR cut filter is removed from the front of the image sensor, and thus light passing through the lens group forms an optical image of an object on the image sensor. In both of the day mode and the night mode, the image sensor photoelectrically converts the optical image formed on the image sensor into an electric signal (analog image signal) and outputs the electric signal.

The CDS circuit performs correlated double sampling processing on the electric signal received from the image sensor.

The AGC amplifier performs gain processing (amplification processing) on the electric signal received from the CDS circuit.

The A/D conversion unit converts the electric signal (analog image signal) subjected to the gain processing (amplification processing) performed by the AGC amplifier into a digital image signal and outputs the digital image signal.

A signal processing unit 102 performs image signal processing, such as white balance (WB) processing and noise reduction (NR) processing, on the digital image signal output from the imaging unit 101 and outputs image data. The signal processing unit 102 also performs processing for calculating a luminance value, i.e., a luminance value of the captured image, from the digital image signal received from the imaging unit 101.

The display unit 105 acquires, via the communication unit 103, the image data output as a result of the image signal processing performed by the signal processing unit 102, and displays an image based on the image data. The display unit 105 also displays a user interface (UI) screen. The display unit 105 can be configured as a part of an external terminal which allows a user to input a control instruction to the image capturing apparatus 100. Further, the display unit 105 can be a touch panel or a screen of a personal computer (PC), and the display unit 105 can display a UI screen that is used by the user to issue an instruction to the image capturing apparatus 100, in accordance with a user operation performed on the touch panel or the PC screen.

The control unit 104 is configured of a central processing unit (CPU), a read only memory (ROM), and a random access memory (RAM) which are not illustrated. The CPU is a central processing unit that controls each function unit of the image capturing apparatus 100 and performs various types of calculation necessary to control each of the function units according to a control program loaded from the ROM. The ROM is a rewritable memory which does not require a memory retention operation. The ROM stores a control program executed by the CPU and various constant numbers necessary to execute a program. The RAM is a rewritable memory which requires a memory retention operation. The RAM is used as a storage area for storing various types of temporary data necessary to execute a program.

The communication unit 103 transmits the image data processed by the signal processing unit 102 to the display unit 105. The communication unit 103 can also transmit the image data processed by the signal processing unit 102 to an external client apparatus or a server. The display unit 105 serving as an output destination of the image data may be a liquid crystal display (LCD) built into the image capturing apparatus 100 or an external display. The communication unit 103 can also acquire control information about a control instruction to the image capturing apparatus 100 input through an external terminal including the display unit 105.

A visible light level acquisition unit 107 is a sensor value acquisition unit which acquires a visible light level detected by a visible light sensor, below-described, included in the image capturing apparatus 100, i.e., a value which represents brightness of visible light detected by the visible light sensor in the image capturing environment. In the present exemplary embodiment, a value which represents brightness of visible light detected by the visible light sensor in the image capturing environment is called a visible light sensor value.

A shifting determination unit 106 performs mode shifting determination to determine whether to shift a mode of the image capturing apparatus 100 to the day mode (first mode) or the night mode (second mode). In other words, the shifting determination unit 106 performs mode shifting determination based on a luminance value of a captured image calculated by the signal processing unit 102 and a visible light sensor value of the image capturing environment acquired by the visible light level acquisition unit 107 from the visible light sensor. Details of the mode shifting determination processing that is performed by the shifting determination unit 106 will be described below.

For example, in a case where the result of the mode shifting determination performed by the shifting determination unit 106 indicates a state of shifting from the day mode to the night mode, the control unit 104 controls the IRCF insertion/removal mechanism to remove the IR cut filter from the front of the image sensor of the imaging unit 101. Further, in a case where the result of the mode shifting determination indicates a state of not shifting from the night mode to the day mode, the control unit 104 controls the IRCF insertion/removal mechanism to set the IR cut filter in the front of the image sensor of the imaging unit 101. In the present exemplary embodiment, although the IRCF insertion/removal mechanism of the imaging unit 101 is controlled by the control unit 104, the IRCF insertion/removal mechanism may be controlled by the shifting determination unit 106.

An illumination control unit 108 performs on/off control of an infrared illumination included in the image capturing apparatus 100. The infrared illumination can be connected to the image capturing apparatus 100 as an external device instead of being included in the image capturing apparatus 100. In a case where the result of the mode shifting determination indicates the state of shifting from the day mode to the night mode, the control unit 104 instructs the illumination control unit 108 to turn on the infrared illumination to emit light. The illumination control unit 108 received the instruction performs control to turn on the infrared illumination. In a case where the result of the mode shifting determination indicates the state of shifting from the night mode to the day mode, the control unit 104 instructs the illumination control unit 108 to turn off the infrared illumination. The illumination control unit 108 received the instruction performs control to turn off the infrared illumination.

As described above, when the image capturing apparatus 100 according to the present exemplary embodiment is in the night mode, the IR cut filter is removed from the front of the image sensor, and the infrared illumination is turned on to emit light. On the other hand, when the image capturing apparatus 100 is in the day mode, the IR cut filter is inserted in the front of the image sensor, and the infrared illumination is turned off.

In the example in FIG. 1, the control unit 104, the shifting determination unit 106, the illumination control unit 108, and the visible light level acquisition unit 107 are illustrated as the separate functional units, and the control unit 104 that includes a CPU executes a control program to control the other functional units. However, the present exemplary embodiment is not limited thereto. For example, the CPU can realize respective functions of the shifting determination unit 106, the illumination control unit 108, and the visible light level acquisition unit 107, in addition to realizing the function of the control unit 104, by executing the control program according to the present exemplary embodiment.

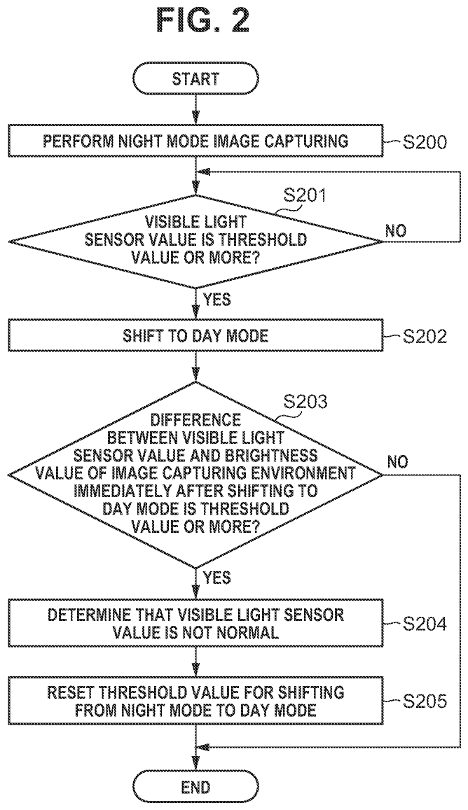

FIG. 2 is a flowchart illustrating auto-day-night (ADN) control of the image capturing apparatus 100 according to the present exemplary embodiment. The flowchart in FIG. 2 illustrates processing procedures performed by the function units of the image capturing apparatus 100 in FIG. 1. The processing illustrated in the flowchart in FIG. 2 is implemented by the CPU loading a control program according to the present exemplary embodiment stored in the ROM onto the RAM and executing the program.

In the example illustrated in FIG. 2, processing for shifting the image capturing apparatus 100 to the day mode from the night mode will be described. In the example case, the image capturing environment is dark. Thus, in step S200, the IR cut filter is set in the front of the image sensor, the infrared illumination is turned on, and image capturing is performed in the night mode.

In step S201, the visible light level acquisition unit 107 acquires a visible light sensor value from the visible light sensor, and the shifting determination unit 106 determines whether the visible light sensor value is a predetermined threshold value or more. The predetermined threshold value used by the shifting determination unit 106 in the step S201 is previously set as a threshold value for determining whether the night mode is to be shifted to the day mode. In the present exemplary embodiment, the threshold value is called a mode shifting threshold value. Then, in a case where the visible light sensor value is less than the mode shifting threshold value (NO in step S201), the shifting determination unit 106 continues performing determination processing in step S201. In other words, in a case where the visible light sensor value is less than the mode shifting threshold value, the image capturing apparatus 100 continues performing image capturing in the night mode. On the other hand, in a case where the visible light sensor value is the mode shifting threshold value or more (YES in step S201), the processing in step S202 and subsequent steps is performed on the image capturing apparatus 100.

In step S202, the shifting determination unit 106 determines that the image capturing apparatus 100 is to be shifted to the day mode. The control unit 104 received a determination result indicating shifting to the day mode from the shifting determination unit 106 controls the IRCF insertion/removal mechanism of the imaging unit 101 to insert the IR cut filter in the front of the image sensor. The control unit 104 instructs the illumination control unit 108 to turn off the infrared illumination, and the illumination control unit 108 performs control to turn off the infrared illumination. By the above-described processing, the mode of the image capturing apparatus 100 in image capturing is changed to the day mode.

In the normal ADN control, in a case where the visible light sensor value is changed from a value less than a mode shifting threshold value to a value greater than or equal to the mode shifting threshold value, the shifting determination unit 106 determines that the image capturing environment has become bright, and shifts the night mode to the day mode. However, in a case where a normal visible light sensor value according to the brightness of the image capturing environment cannot be acquired because of dust or dirt adhered to the visible light sensor and on the periphery of the visible light sensor, the image capturing apparatus 100 cannot be shifted to the day mode even if the image capturing environment has actually become bright.

Thus, in the present exemplary embodiment, in step S203, the control unit 104 acquires exposure parameters, such as an aperture value, a shutter speed, and a gain value used for gain processing, from the imaging unit 101 immediately after the night mode is shifted to the day mode. Then, the control unit 104 estimates a brightness of visible light in the image capturing environment, based on the exposure parameters acquired from the imaging unit 101.

In other words, the control unit 104 has a function for operating as an estimated value acquisition unit which acquires an estimated brightness value of visible light in the image capturing environment. Further, the control unit 104 compares the estimated brightness value of visible light in the image capturing environment and a visible light sensor value acquired by the visible light level acquisition unit 107 from the visible light sensor. In the present exemplary embodiment, as a value which represents a result of the comparison, the control unit 104 calculates a difference value between the estimated brightness value of visible light (a second visible light level) and the visible light sensor value (a first visible light level) in the image capturing environment. Then, the control unit 104 determines whether the difference value between the estimated brightness value of visible light and the visible light sensor value in the image capturing environment is a preset predetermined threshold value or more. In the present exemplary embodiment, the preset predetermined threshold value that is used for comparison with the difference value between the estimated brightness value of visible light and the visible light sensor value in the image capturing environment is called a difference threshold value. In a case where the difference value between the estimated brightness value of visible light and the visible light sensor value is the difference threshold value or more (YES in step S203), the control unit 104 performs the processing in step S204.

In a case where the difference value is the difference threshold value or more, and the processing proceeds to step S204, in step S204, the control unit 104 determines that a normal visible light sensor value is not acquired by the visible light sensor, and the processing proceeds to step S205. On the other hand, in step S203, in a case where the difference value is less than the difference threshold value (NO in step S203), the control unit 104 determines that a normal visible light sensor value is acquired by the visible light sensor, and controls the function units to continue performing image capturing in the day mode.

In step S205, the control unit 104 resets the mode shifting threshold value used for shifting the night mode to the day mode.

For example, a description is given of a case where a mode shifting threshold value set before resetting is 10 lux (lx), and a visible light sensor value acquired at a timing immediately after the night mode is shifted to the day mode is 10 lx, but a brightness value of visible light in the image capturing environment estimated at the timing is 20 lx. In this case, when the brightness value of visible light in the image capturing environment becomes 20 lx, the visible light sensor acquires a visible light sensor value indicating a state that the brightness value of visible light in the image capturing environment is 10 lx. Consequently, the control unit 104 determines that the visible light sensor value becomes the mode shifting threshold value or more, which means that the mode is changed from the night mode to the day mode. In this case, the visible light sensor acquires a visible light sensor value corresponding to only half the actual brightness value of visible light in the image capturing environment. As described above, in a case where the acquired visible light sensor value is half the estimated brightness value of visible light in the actual image capturing environment, the control unit 104 reduces the mode shifting threshold value to half, i.e., the control unit 104 resets the mode shifting threshold value to 5 lx, a value half of 10 lx. In other words, in a case where the night mode is to be shifted to the day mode when the actual brightness value of visible light in the image capturing environment becomes 10 lx, the control unit 104 resets the mode shifting threshold value to 5 lx if the visible light sensor can acquire only half the actual brightness value of visible light. In this way, the night mode can be shifted to the day mode when the actual brightness value of visible light in the image capturing environment becomes 10 lx. As described above, even in a case where the visible light sensor value does not become a value estimated previously, the image capturing apparatus 100 according to the present exemplary embodiment can shift the night mode to the day mode at an appropriate timing by resetting the mode shifting threshold value.

Another method can also be used for resetting the mode shifting threshold value. For example, the mode shifting threshold value can be reset by lowering a selectable threshold value by one level by a user operation performed on the UI screen.

Further, in the estimation method according to the present exemplary embodiment, a brightness value of the image capturing environment is estimated from the exposure parameters. However, another estimation method can also be used as long as the brightness value of the image capturing environment can be estimated and compared to the visible light sensor value.

The mode shifting threshold value and the difference threshold value can previously be set based on estimation accuracy of the brightness of the image capturing environment or performance of the visible light sensor. Further, the mode shifting threshold value and the difference threshold value can be set on the UI screen.

In the present exemplary embodiment, the determination is performed at a timing immediately after the night mode is shifted to the day mode. However, the determination can be performed at a different timing in accordance with specifications or configurations of a product, as long as determination is performed in the day mode.

Further, in a case where estimation accuracy of the brightness of the image capturing environment or performance of the visible light sensor is relatively low, the control unit 104 can determine that the acquired visible light sensor value is not normal, based on the number of times where the difference value between the brightness value of the image capturing environment and the visible light sensor value becomes the difference threshold value or more. In this case, in step S203, the control unit 104 counts the number of times where the difference value between the brightness value of the image capturing environment and the visible light sensor value becomes the difference threshold value or more. Then, as the processing in step S204, the control unit 104 determines that the visible light sensor value is not normal when the count value exceeds a predetermined count threshold value. As described above, it is possible to reduce the effects of disturbances by performing determination based on a comparison between the count value, which represents the number of times where the difference value between the brightness value of the image capturing environment and the visible light sensor value becomes the difference threshold value or more, and the predetermined count threshold value.

As described above, according to the image capturing apparatus 100 including the ADN function and the visible light sensor described in the present exemplary embodiment, ADN control can be performed appropriately even in a case where the visible light sensor cannot acquire a normal visible light sensor value because of, for example, dirt caused by wind and rain or dust.

After the mode shifting threshold value is reset as described above, and in a case where a normal value can be acquired by the visible light sensor because the wind and rain subside or dirt is removed, for example, the mode shifting threshold value has to be returned to a value set before the resetting. Thus, the mode shifting threshold value may be returned to a value set before the resetting in a case where a difference between the brightness value of the image capturing environment and the visible light sensor value becomes less than the difference threshold value. Alternatively, in a case where the network camera is restarted, the mode shifting threshold value can be returned to a value set before the resetting (e.g., initial value).

In the first exemplary embodiment, the control unit 104 compares the visible light sensor value with the brightness value of the image capturing environment estimated from the captured image and the exposure parameters, and determines whether a value of the visible light sensor is acquired normally by calculating a difference as a comparison result. However, in a case where the visible light sensor value becomes less than the estimated value because of dirt on the visible light sensor and on the periphery of the visible light sensor caused by wind and rain, the visible light sensor value is not always reduced by a certain value. In other words, when a brightness value of the image capturing environment is increased significantly, the visible light sensor value may be lowered by a light reduction rate different from a light reduction rate of the visible light sensor value which is lowered when a brightness value thereof becomes close to the mode shifting threshold value for shifting the night mode to the day mode. Thus, if possible, in order to reset the mode shifting threshold value for shifting the night mode to the day mode, it is desirable that the control unit 104 determines whether the visible light sensor value is normal at the brightness value around the mode shifting threshold value for shifting the night mode to the day mode.

Thus, the present exemplary embodiment will be described with respect to a case where the control unit 104 determines whether a visible light sensor value is normal at the brightness value around the mode shifting threshold value for shifting the night mode to the day mode. The same reference numerals are applied to configurations and processing similar to those described in the first exemplary embodiment, and the redundant descriptions will be omitted.

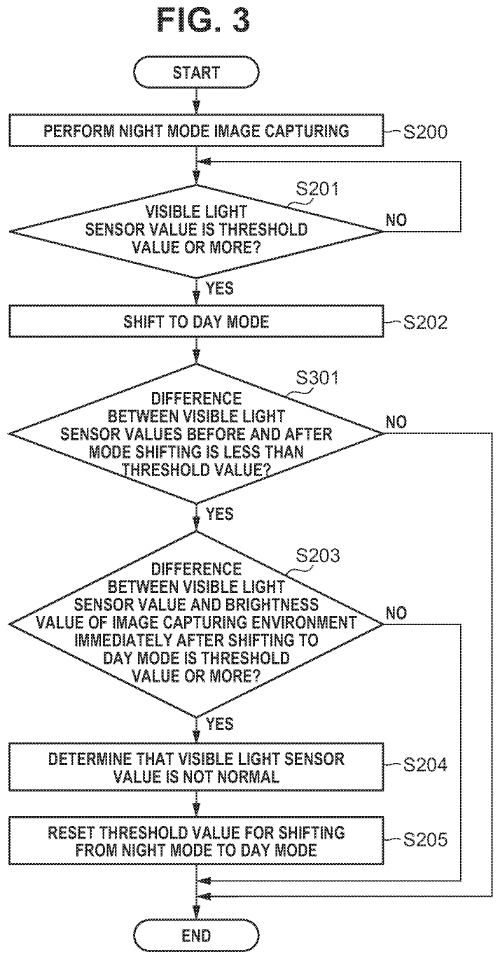

FIG. 3 is a flowchart illustrating ADN control of the image capturing apparatus 100 according to the present exemplary embodiment. The flowchart in FIG. 3 illustrates processing procedures performed by the function units of the image capturing apparatus 100 in FIG. 1. The processing illustrated in the flowchart in FIG. 3 is implemented by the CPU loading a control program according to the present exemplary embodiment stored in the ROM onto the RAM and executing the control program. The same reference numerals are applied to the processing steps similar to the processing steps illustrated in the above-described flowchart in FIG. 2, and the redundant descriptions will be omitted.

The processing in steps S200 to S202 is similar to the processing described in the first exemplary embodiment, and thus the redundant descriptions will be omitted. In the present exemplary embodiment, after the processing in step S202, the image capturing apparatus 100 performs the processing in step S301.

When the processing proceeds to step S301, the control unit 104 acquires visible light sensor values set before and after the night mode is shifted to the day mode, calculates a difference between the visible light sensor values set before and after mode shifting, and compares the difference with a preset predetermined threshold value. In the present exemplary embodiment, this predetermined threshold value previously set and compared to a difference between the visible light sensor values set before and after mode shifting is called a before-after difference threshold value. Then, in a case where a difference between the visible light sensor values set before and after mode shifting is less than the before-after difference threshold value (YES in step S301), the processing proceeds to step S203 and subsequent steps. In steps S203 to S205, the processing similar to the processing described in the first exemplary embodiment is performed. In a case where a difference between the visible sensor values set before and after mode shifting is small, the control unit 104 can determine that the image capturing environment gradually becomes brighter. Thus, the control unit 104 determines that the night mode is shifted to the day mode at a brightness value around the mode shifting threshold value for shifting the night mode to the day mode.

On the other hand, in a case where a difference between the visible light sensor values set before and after the mode shifting is the before-after difference threshold value or more (NO in step S301), it can be said that the image capturing environment rapidly becomes brighter. Thus, the control unit 104 determines that the night mode is shifted to the day mode in the image capturing environment having the brightness value greater than a value around the mode shifting threshold value for shifting the night mode to the day mode. Thus, the control unit 104 does not reset the mode shifting threshold for shifting the night mode to the day mode, and controls the units to continue performing image capturing in the day mode.

The before-after difference threshold value of the difference between the visible light sensor values set before and after mode shifting can previously be set based on the performance of the image capturing apparatus, or can be set by the user on the UI screen.

As described above, according to the present exemplary embodiment, it is possible to determine whether a visible light sensor value is normal at the brightness value around the mode shifting threshold value for shifting the night mode to the day mode.

In the first exemplary embodiment, the control unit 104 determines whether a visible light sensor value is acquired normally, based on a difference calculated as a result of comparison between the visible light sensor value and the estimated brightness value of the image capturing environment, and the mode shifting threshold value for shifting the night mode to the day mode is configured to be resettable, based on the determination result. In a case where the visible light sensor and on the periphery of the visible light sensor are covered in dirt because of wind and rain, a degree of the dirt and severity of the effects of the dirt on the visible light sensor may vary depending on the situation. Thus, in order to make the visible light sensor exercise its true ADN ability, it is desirable that the user removes dirt from the visible light sensor.

In the present exemplary embodiment, in a case where a determination result indicates a state that a value acquired by the visible light sensor is not normal, the control unit 104 notifies the user that the visible light sensor may be covered in dirt. The same reference numerals are applied to the configurations and processing similar to those described in the first exemplary embodiment, and the redundant descriptions will be omitted.

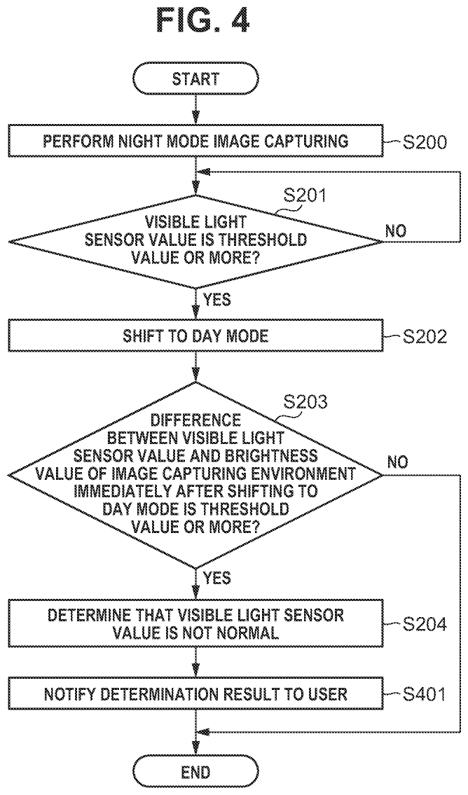

FIG. 4 is a flowchart illustrating ADN control of the image capturing apparatus 100 according to the present exemplary embodiment. The flowchart in FIG. 4 illustrates processing procedures performed by the function units of the image capturing apparatus 100 in FIG. 1. The processing illustrated in the flowchart in FIG. 4 is implemented by the CPU loading a control program according to the present exemplary embodiment stored in the ROM onto the RAM and executing the control program. The same reference numerals are applied to the processing steps similar to the processing steps illustrated in the above-described flowchart in FIG. 2, and the redundant descriptions will be omitted.

The processing in steps S200 to S204 is similar to the processing described in the first exemplary embodiment, and thus, the redundant descriptions will be omitted. In the present exemplary embodiment, after the processing in step S204, the image capturing apparatus 100 performs the processing in step S401.

When the processing proceeds to step S401, the control unit 104 generates a message, such as “the acquired visible light sensor value is not normal”, and displays the message on the display unit 105 via the communication unit 103. By the above processing, the message, such as “the acquired visible light sensor value is not normal” is notified to the user. In the present exemplary embodiment, although the user is notified of a determination result by a message displayed on the display unit 105, another configuration or notification method can also be used.

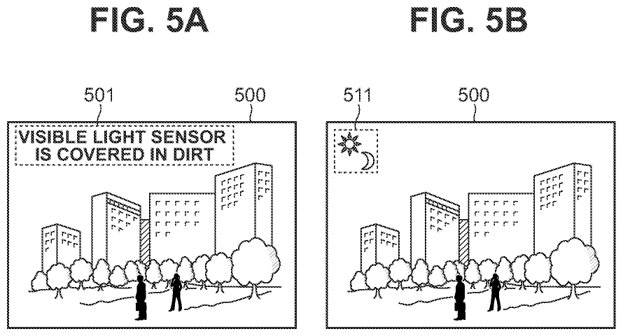

FIGS. 5A and 5B are diagrams illustrating examples of a display screen and a notification message displayed on the display unit 105. In the example illustrated in FIG. 5A, a notification is issued by superimposing and displaying an overlay including a sentence 501 on a screen 500. The sentence 501 is an example, and another wording or expression can also be used. For example, “visible light sensor” in the sentence 501 may be changed to “illumination sensor” or “light sensor” which the user can understand more easily, and “visible light sensor is covered in dirt” may be changed to another expression, such as “please clean up the surface of the camera main body”.

In the example illustrated in FIG. 5B, a notification is issued by displaying an ADN icon 511 on the screen 500. The control unit 104 displays the ADN icon 511 on the screen 500, and makes the ADN icon 511 blink to notify the user of malfunctions of the visible light sensor. Although an ADN icon is used in this example, an icon illustrating the visible light sensor or another icon can also be used as long as the user can understand the contents of the message.

As described above, according to the present exemplary embodiment, it is possible to notify the user that the visible light sensor is covered in dirt.

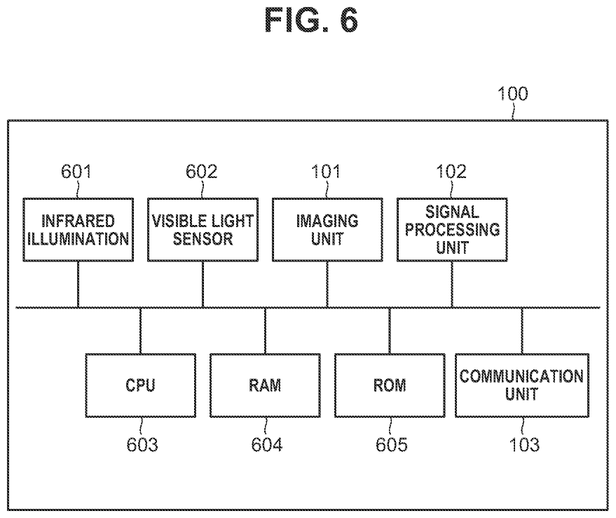

FIG. 6 is a diagram illustrating an example of the hardware configuration of the image capturing apparatus 100 according to any one of the first to the third exemplary embodiments. Descriptions of the constituent elements of the image capturing apparatus 100 common to those illustrated in FIG. 1 are omitted. Specifically, the redundant descriptions of the imaging unit 101, the signal processing unit 102, and the communication unit 103 are omitted.

The image capturing apparatus 100 includes an infrared illumination 601, a visible light sensor 602, a CPU 603, a RAM 604, and a ROM 605. The infrared illumination 601 is a light emission apparatus which emits illumination light to an image capturing area and an object. Specifically, the infrared illumination 601 emits infrared illumination light (infrared light). The infrared illumination 601 emits infrared light according to an instruction from the illumination control unit 108. More specifically, infrared light is emitted when a mode of the image capturing apparatus 100 is the night mode (i.e., second mode), and infrared light is not emitted when a mode of the image capturing apparatus 100 is the day mode. Further, the light-emission intensity of infrared illumination light can be adjusted. Emission of infrared illumination light and light-emission intensity of the infrared illumination 601 are controlled by the illumination control unit 108. The infrared illumination 601 may be arranged to be independent from the image capturing apparatus 100. In this case, the infrared illumination 601 receives an instruction from the illumination control unit 108 by communicating with the image capturing apparatus 100 via the communication unit 103.

The visible light sensor 602 is a sensor having sensitivity to light within a visible range (e.g., wavelength of 380 to 780 nm) from among the light received by the visible light sensor 602, and the visible light sensor 602 detects brightness (luminance value) of the received visible light as a visible light level. Because the visible light sensor 602 is a sensor for measuring the visible light level in the image capturing environment of the image capturing apparatus 100, it is desirable that the visible light sensor 602 is arranged at a position relatively close to the imaging unit 101. The visible light level detected by the visible light sensor 602 is acquired by the visible light level acquisition unit 107. Similar to the infrared illumination 601, the visible light sensor 602 may be arranged to be independent from the image capturing apparatus 100.

The CPU 603 is a processor which collectively controls the image capturing apparatus 100. The flowcharts illustrated in FIGS. 2 and 3 are implemented by the CPU 603 loading a program stored in the ROM 605 onto the RAM 604 and executing the program.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-139715, filed Aug. 30, 2021, which is hereby incorporated by reference herein in its entirety.

What is claimed is:

1. An image capturing apparatus that shifts an image capturing mode between a first mode in which a filter for attenuating infrared light is inserted to an optical path of an imaging optical system and a second mode in which the filter is removed from the optical path of the imaging optical system and captures an image by the imaging optical system, the image capturing apparatus comprising:
a control unit configured to shift the second mode to the first mode, based on a predetermined threshold value;
an acquisition unit configured to acquire, in a case where the second mode is shifted to the first mode, a parameter regarding exposure of the image capturing apparatus and a first visible light level indicating brightness of visible light detected by a visible light sensor; and
an estimation unit configured to estimate a second visible light level indicating brightness of visible light entering an image sensor of the image capturing apparatus, based on the parameter regarding exposure,
wherein the control unit determines whether the first visible light level detected by the visible light sensor is normal, based on a difference value between the first visible light level and the second visible light level, and
wherein the control unit changes the predetermined threshold value, based on a result of the determination.

2. The image capturing apparatus according to claim 1, wherein, in a case where the difference value becomes a predetermined difference threshold value or more, the control unit determines that the first visible light level detected by the visible light sensor is not normal.

3. The image capturing apparatus according to claim 1, wherein the control unit counts the number of times where the difference value becomes the predetermined difference threshold value or more, and in a case where the number of times exceeds a predetermined count threshold value, the control unit determines that the first visible light level detected by the visible light sensor is not normal.

4. The image capturing apparatus according to claim 1, wherein, in a case where the control unit determines that the first visible light level is not normal, the control unit changes the predetermined threshold value, and in a case where the control unit determines that the first visible light level is normal, the predetermined threshold value is unchanged.

5. The image capturing apparatus according to claim 1,
wherein the acquisition unit acquires the first visible light level in the second mode, and
wherein, in a case where the first visible light level becomes the predetermined threshold value or more in the second mode, the control unit shifts the second mode to the first mode.

6. The image capturing apparatus according to claim 1, wherein, in a case where the control unit determines that the first visible light level is not normal, the control unit changes and lowers the predetermined threshold value.

7. The image capturing apparatus according to claim 2, wherein, in a case where the difference value is less than the predetermined difference threshold value after the predetermined threshold value is changed, the control unit returns the predetermined threshold value to a value set before the changing of the predetermined threshold value.

8. The image capturing apparatus according to claim 1,
wherein, in a case where the second mode is shifted to the first mode, the acquisition unit acquires the first visible light level in the first mode and the first visible light level in the second mode, and
wherein, in a case where a difference value between the first visible light level in the first mode and the first visible light level in the second mode is less than a predetermined before-after difference threshold value, the control unit determines whether the first visible light level is normal.

9. The image capturing apparatus according to claim 1, wherein, in a case where the control unit determines that the first visible light level is not normal, the control unit notifies a result of the determination to a user.

10. The image capturing apparatus according to claim 1, further comprising an illumination control unit configured to turn on an infrared illumination in the second mode and to turn off the infrared illumination in the first mode.

11. A control method of an image capturing apparatus that shifts an image capturing mode between a first mode in which a filter for attenuating infrared light is inserted to an optical path of an imaging optical system and a second mode in which the filter is removed from the optical path of the imaging optical system to capture an image by the imaging optical system, the control method comprising:
shifting the second mode to the first mode based on a predetermined threshold value;
acquiring, in a case where the second mode is shifted to the first mode, a parameter regarding exposure of the image capturing apparatus and a first visible light level indicating brightness of visible light detected by a visible light sensor; and
estimating a second visible light level indicating brightness of visible light entering an image sensor of the image capturing apparatus, based on the parameter regarding exposure,
determining whether the first visible light level detected by the visible light sensor is normal, based on a difference value between the first visible light level and the second visible light level, and
changing the predetermined threshold value, based on a result of the determination.

12. A non-transitory computer-readable storage medium configured to execute a control method of an image capturing apparatus that shifts an image capturing mode between a first mode in which a filter for attenuating infrared light is inserted to an optical path of an imaging optical system and a second mode in which the filter is removed from the optical path of the imaging optical system to capture an image by the imaging optical system, the control method comprising
shifting the second mode to the first mode based on a predetermined threshold value;
acquiring, in a case where the second mode is shifted to the first mode, a parameter regarding exposure of the image capturing apparatus and a first visible light level indicating brightness of visible light detected by a visible light sensor; and
estimating a second visible light level indicating brightness of visible light entering an image sensor of the image capturing apparatus, based on the parameter regarding exposure,
determining whether the first visible light level detected by the visible light sensor is normal, based on a difference value between the first visible light level and the second visible light level, and
changing the predetermined threshold value, based on a result of the determination.
